(19) United States
(12) Patent Application Publication
(10) Pub. No.: US 2025/0224758 A1
(43) Pub. Date: Jul. 10, 2025

(54) OPTICAL ISING MACHINE

(71) Applicant: NATIONAL UNIVERSTIY OF SINGAPORE, Singapore (SG)

(72) Inventors: Yuchi LAN, Singapore (SG); Guanyu CHEN, Singapore (SG); Yuan GAO, Singapore (SG); Aaron James DANNER, Singapore (SG)

(73) Assignee: NATIONAL UNIVERSTIY OF SINGAPORE, Singapore (SG)

(21) Appl. No.: 19/013,475

(22) Filed: Jan. 8, 2025

(30) Foreign Application Priority Data
Jan. 8, 2024 (SG) 10202400065W

(51) Int. Cl. G06E 1/04; G06N 7/01

(52) U.S. Cl. CPC G06E 1/045; G06N 7/01

(57) ABSTRACT

An optical Ising machine and a method of applying an optical Ising machine for solving a combinatorial optimization problem. The method comprises the steps of splitting a reference optical signal into M beams and at least one reference beam; encoding an input vector of size M by respective amplitudes and/or phases of the M beams; performing multiplication of the input vector of size M and a matrix of size M×M to generate an output vector of size M encoded on the M beams; extracting respective amplitudes and phases of the M beams after the optical matrix processing unit using the reference beam for determining components of the output vector of size M; and applying new phase biases in the encoding of respective ones of the M beams based on the components of the output vector of size M for a next iteration of the optical Ising machine.

### CROSS-REFERENCE TO RELATED APPLICATION

This application claims the benefit of priority of Singapore patent application Ser. No. 10/202,400065W filed on Jan. 8, 2024, the content of which is incorporated herein by reference in its entirety for all purposes.

### FIELD OF INVENTION

The present invention relates broadly to an optical Ising machine and to a method of applying an optical Ising machine for solving a combinatorial optimization problem, in particular to an optical Ising machine design and algorithm which permits all-optical calculation of the Ising interactions and is scalable.

### BACKGROUND

Any mention and/or discussion of prior art throughout the specification should not be considered, in any way, as an admission that this prior art is well known or forms part of common general knowledge in the field.

Ising machines, designed in various forms within fields spanning photonics and electronics, have gained prominence in recent years.

The research significance of the optical Ising machine lies in its capacity to address combinatorial optimization problems through the mapping of these problems to the ground state search of the Ising model. The job of an Ising machine/Ising computer is to minimize the Hamiltonian

$$H = - \frac{1}{2} {\sum }_{m , n}^{N} {J}_{m n} {σ}_{m} {σ}_{n} ,$$

and in the process determine σ given J. Keeping in mind that J is constant, the process of finding the correct spin states is typically iterative, with candidate spin states σ updated algorithmically.

Notably, in optical Ising machines, a key mathematical operation necessitates repeated matrix-vector multiplication, with the vector size limited by the physical dimensions of the optical system.

Embodiments of the present invention seek to address at least one of the above problems.

### SUMMARY

In accordance with a first aspect of the present invention, there is provided an optical Ising machine comprising:
a splitting tree for splitting a reference optical signal into M beams and at least one reference beam;
M intensity and/or phase modulators to encode an input vector of size M by respective amplitudes and/or phases of the M beams;
an optical matrix processing unit configured to perform multiplication of the input vector of size M and a matrix of size M×M to generate an output vector of size M encoded on the M beams;
a homodyne detection circuit configured to extract respective amplitudes and phases of the M beams after the optical matrix processing unit for determining components of the output vector of size M; and
a feedback circuit for applying new phase biases to respective ones of the M intensity and/or phase modulators based on the components of the output vector of size M for a next iteration of the optical Ising machine.

In accordance with a second aspect of the present invention, there is provided a method of applying an optical Ising machine for solving a combinatorial optimization problem, the method comprising the steps of:
splitting a reference optical signal into M beams and at least one reference beam;
encoding an input vector of size M by respective amplitudes and/or phases of the M beams;
performing multiplication of the input vector of size M and a matrix of size M×M to generate an output vector of size M encoded on the M beams;
extracting respective amplitudes and phases of the M beams after the optical matrix processing unit using the reference beam for determining components of the output vector of size M; and
applying new phase biases in the encoding of respective ones of the M beams based on the components of the output vector of size M for a next iteration of the optical Ising machine.

### BRIEF DESCRIPTION OF THE DRAWINGS

Embodiments of the invention will be better understood and readily apparent to one of ordinary skill in the art from the following written description, by way of example only, and in conjunction with the drawings, in which:

FIG. 1 shows a schematic diagram illustrating the implementation of an optical Ising machine, according to an example embodiment.

FIG. 2 shows a schematic diagram illustrating a non-limiting example of the design of a Matrix Processing Unit (MPU) for use in an optical Ising machine according to an example embodiment, specifically in a 4×4 optical Ising machine according to an example embodiment. The process commences with an input coherent beam, which is split into M equivalent beams, in this example embodiment, M=4. These beams pass through a series of Mach-Zehnder interferometers (MZIs) to represent the matrix V^{T}, followed by M attenuators which represents Σ. Finally, another set of MZIs is utilized, representing U.

FIG. 3 shows a flowchart illustrating a method of applying an optical Ising machine for solving a combinatorial optimization problem, according to an example embodiment.

### DETAILED DESCRIPTION

In response to the challenge described in the background section above, example embodiments of the present invention provide a scalable optical Ising machine, leveraging matrix partitioning and phase encoding. An example embodiment can enable the use of compact optical circuits to manipulate exceedingly large spin vectors. Preferably, all intricate calculations are executed optically rather than electronically, marking a significant departure from existing approaches. Example embodiments of the present invention can be implemented both in free space and integrated photonics platforms, advantageously allowing for the resizing of the required surface area based on convenience while considering the trade-off in solution time. Preferably, this trade-off does not compromise the algorithm's effectiveness. The results according to an example embodiment described herein indicate that the system is poised to deliver a high success rate, robust noise tolerance, and superior error tolerance, underlining its potential for addressing complex optimization challenges.

Example embodiments of the present invention are based on simulated bifurcation, upon which the spin-coupled system spontaneously evolves towards a fixed equilibrium point, ideally corresponding to the ground state of an Ising problem. In example embodiments of the present invention, the minimization of the Hamiltonian involves an algorithm that can be implemented all-optically and is thus extremely fast. Furthermore, the design according to an example embodiment described herein allows matrix partitioning such that the number of spin states o is not limited by the physical chip area (that is, the problem can be partitioned).

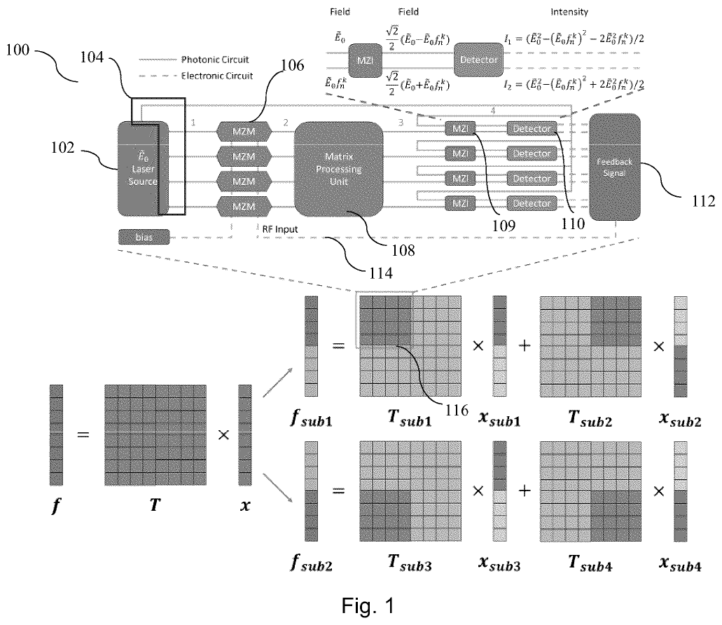

FIG. 1 shows a schematic diagram illustrating an optically implemented Ising machine 100 according to an example embodiment, with matrix partitioning. A single laser 102 provides a reference beam with an amplitude of \tilde{E}₀, which is divided through a splitting tree 104 into N beams plus at least one reference beam (indicated at numeral 105), all of uniform global phase shifts, indicated for N=4 in FIG. 1 by way of example only. Referring to FIG. 1, one can denote the electrical field of each beam light at position “1” as \tilde{E}₀. Each beam is directed through a Mach-Zehnder intensity modulator (MZM) e.g. 106, and although the π/2 phase shift from the MZM e.g. 106 in Equation (1) effectively gives a sine, it is interpreted as a cosine with a bias so that a standard MZM can be used in an example implementation. In Equation (1), the status of n^{th} spin during the k^{th} iteration is represented by xₙ^{k}, an analog value that ranges between −1 and +1. The vector components fₙ^{k} are electronically imparted to phase modulators within the MZMs e.g. 106 between positions “1” and “2”, and gₙ^{k} is the noise.

$${x}_{n}^{k} = cos ( {f}_{n}^{k} + {g}_{n}^{k} - \frac{π}{2} ) \qquad ( 1 )$$

$${f}_{n}^{k + 1} = a {x}_{n}^{k} + b {\sum }_{m , n}^{N} {J}_{m n} {x}_{m}^{k} \qquad ( 2 )$$

The fields at position “2” become \tilde{E}ₙ^{k}=\tilde{E}₀sin φₙ^{k}=\tilde{E}₀xₙ^{k}, where φₙ^{k} is the additional phase shift introduced along one MZM arm where the global additional phase shift has been ignored, noting that it is not important/insignificant for the mathematical analysis, as will be appreciated by a person skilled in the art. Here, in the example embodiment sin φₙ^{k}=sin(fₙ^{k}+gₙ^{k}) although other nonlinear functions are plausible as well, as will be appreciated by a person skilled in the art. This shows that the vector components fₙ^{k} are electronically imparted to phase modulators within the MZMs between positions “1” and “2”, and along with noise gₙ^{k} they become the total phase φₙ^{k}=fₙ^{k}+gₙ^{k}. It is noted that the vector x^{k} is completely encoded by the amplitude \tilde{E}₀ of the N light beams, and it has been shown that any linear mathematical operation on this set of numbers can be accomplished by a mesh of MZIs, see as described, for example, in Reck, M., et al., Experimental realization of any discrete unitary operator. Physical Review Letters, 1994. 73(1): p. 58-61, and Clements, W.R., et al., Optimal design for universal multiport interferometers. Optica, 2016. 3(12): p. 1460.

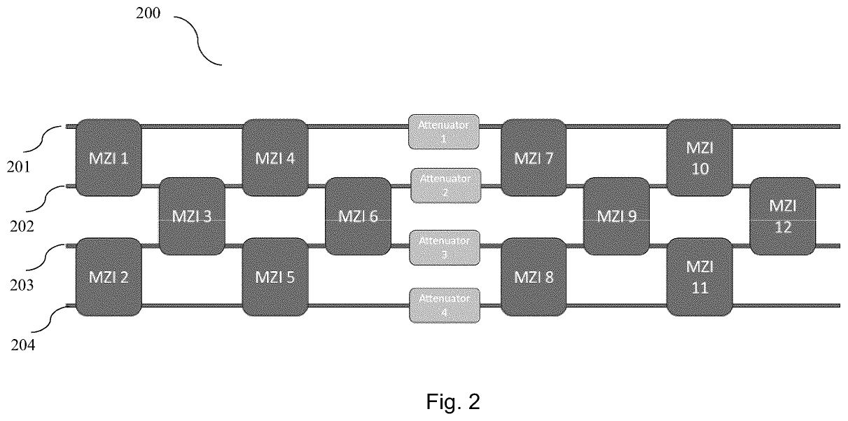

A “Matrix Processing Unit (MPU)” 108, equipped with suitable programming that incorporates the matrix J, an example implementation of which according to an example embodiment will be described with reference to FIG. 2 below, subsequently produces the result denoted as f^{k′}. So at position “3”, i.e. before M Mach Zehnder interferometers e.g. 109 and M detectors e.g. 110, the field is \tilde{E}ₙ^{k′}=Σᵢ₌₁^{M}Tₙᵢ\tilde{E}ᵢ^{k}=\tilde{E}₀Σᵢ₌₁^{M}Tₙᵢxᵢ^{k}=\tilde{E}₀fₙ^{k}. If one were to measure the intensity of the beams at position “3”, one could hypothetically determine fₙ^{k} but without its sign; in the example embodiment, therefore, homodyne detection (HD) is used, implemented by the M Mach Zehnder interferometers e.g. 109 and M detectors e.g. 110. This permits extraction of both amplitude and phase of \tilde{E}ₙ^{k′}, allowing one to find |fₙ^{k}| from the amplitude and its sign from the phase.

At position 4, the fields corresponding to a particular \tilde{E}ₙ^{k′} before and the intensities I_{1,2} measured after homodyne detection are depicted in the upper section of FIG. 1. To obtain fₙ^{k}, one need only to electronically subtract the two measured intensities and scale by a constant factor, which is advantageously simple enough that it can be implemented with analog electronic circuitry, indicated at numeral 112, for the RF feedback signal 114 generation for the respective MZM, e.g. 106, when the matrix as a whole is finished, i.e. analog electronic circuitry 112 functions as data storage for each partition at the output and provides the RF feedback signal 114 from storage once all partitions are done, as will be described below. New phase biases

$${f}_{n}^{k} = \frac{{I}_{2} - {I}_{1}}{{\tilde{2 ( {E}_{0} )}}^{2}}$$

are then arranged accordingly for the subsequent iteration and the process repeats, according to the example embodiment. The process according to the example embodiment essentially achieves all-optical computation with no electronic bottleneck, noting again that the analog electronic circuitry 112 only performs simple processes as mentioned above. It is plausible that the entire feedback system can be implemented with fast analog electronics, eliminating analog-digital conversion in the measurement process as well according to an example embodiment.

In practice, for a given Ising problem, N can be an exceedingly large number, making it impractical to have N beams exiting the splitting tree (compare numeral 104 in FIG. 1) on a single chip. In the example embodiment shown in FIG. 1, the number of waveguides after the splitting tree 104, M, is less than N. In this example embodiment, the large matrix T of size N by N is partitioned into sub-matrices T_{sub} of size M by M and the partitions are dealt with sequentially. Rather than directly processing T, the MPU 108 now exclusively handles a smaller T_{sub}.

Consider as an example an MPU 108 limited to M=4 as shown in FIG. 1. The 4×4 sub-matrix T_{sub} is decomposed as U·E·V^{T} using singular value decomposition, which only needs to be done once in this example embodiment.

It is noted that in this example embodiment, encoding is done as real numbers (i.e. real number vectors) which is a typical scenario for the Ising machine. Therefore, in this example embodiment, at the input only intensity modulation are needed and at the output homodyne detection is used only to extract the sign of the amplitude (rather than some other phase than 0 and 180 degrees). However, another example embodiment can be made to work with complex numbers (i.e. complex number vectors) by using the full homodyne detection at the output (using the same hardware as in the embodiment in FIG. 1) and encoding both phase and amplitude at the input, using amplitude and phase modulation. In yet another example embodiment, only phase modulation may be used at the input.

FIG. 2 illustrates a non-limiting example design of a 4×4 MPU 200 for use in the Ising machine according to an example embodiment (compare 108 in FIG. 1). In this illustration, M=4, and M (M−1) MZIs are used in the example implementation of the MPU 200. The split beams at numerals 201-204 pass through a first set of MZI 1-6 to represent the matrix V^{T}, followed by M attenuators₁₋₄ which represents Σ. Finally, a second set of MZI 7-12 is utilized, representing U. Any matrix comprising N elements can be partitioned into multiple sub-matrices, each containing M elements. As the light traverses the MPU 200, each pass processes a sub-matrix, as indicated e.g. at 116 in FIG. 1. In cases where the total number of elements N is not evenly divisible by M, the surplus elements can be populated with zeros. In this way, σ and J can be divided into [N/M] sub-vectors and [N/M]² submatrices, respectively.

$${S}_{{MZI}_{i = 1 , 4 , 7 , 10}} = ( \begin{matrix}cos {θ}_{i} & - sin {θ}_{i} & & \\ sin {θ}_{i} & cos {θ}_{i} & & \\ & & 1 & \\ & & & 1\end{matrix} ) , \\ {S}_{{MZI}_{i = 2 , 5 , 8 , 11}} = ( \begin{matrix}1 & & & \\ & 1 & & \\ & & cos {θ}_{i} & - sin {θ}_{i} \\ & & sin {θ}_{i} & cos {θ}_{i}\end{matrix} ) , \\ {S}_{{MZI}_{i = 3 , 6 , 9 , 12}} = ( \begin{matrix}1 & & & \\ & cos {θ}_{i} & - sin {θ}_{i} & \\ & sin {θ}_{i} & cos {θ}_{i} & \\ & & & 1\end{matrix} ) \qquad ( 3 )$$

$${S}_{att} = ( \begin{matrix}cos {δ}_{1} & & & \\ & cos {δ}_{2} & & \\ & & cos {δ}_{3} & \\ & & & cos {δ}_{4}\end{matrix} ) \qquad ( 4 )$$

$${T}_{s u b} \cdot {x}^{k} = U \cdot \sum \cdot {V}^{T} \cdot {x}^{k} = ( {S}_{{MZI}_{12}} \cdot {S}_{{MZI}_{11}} \cdot {S}_{{MZI}_{10}} \cdot {S}_{{MZI}_{9}} \cdot {S}_{{MZI}_{8}} \cdot {S}_{{MZI}_{7}} ) \cdot {S}_{a t t} \cdot ( {S}_{{MZI}_{6}} \cdot {S}_{{MZI}_{5}} \cdot {S}_{{MZI}_{4}} \cdot {S}_{{MZI}_{3}} \cdot {S}_{{MZI}_{2}} \cdot {S}_{{MZI}_{1}} ) \cdot {x}^{k} \qquad ( 5 )$$

Equations (3) and (4) represent the scattering matrices of the MZIs inside the MPU in an example where to M=4, where both parameters θᵢ and δₙ can be adjusted. Each MZI implements a rotation matrix multiplier, affecting the phases of the two input beams. Each attenuator scales the magnitude. In this example embodiment, the two sets MZI 1-6, MZI 7-12 of MZIs will act as the two unitary matrices U and V^{T} while the row of attenuators₁₋₄ acts as the diagonal matrix Σ. Equation (5) mathematically outlines the functioning of the MPU 200 for use in an optical Ising machine according to this example embodiment, when applied to the input light. The calculation of parameters θᵢ and δₙ from a particular matrix T_{sub} is known [see e.g. Clements, William R., et al. “Optimal design for universal multiport interferometers.” Optica 3.12 (2016): 1460-1465.], but it is notable that because for any given Ising problem the J is fixed (and hence all the T_{sub} are constant), the calculation of these parameters preferably needs to be done only a single time. As the optical Ising machine 100 according to an example embodiment iterates through various sub-matrices, the appropriate parameters θᵢ and δₙ are applied to the optical components within the MPU 200, but no further calculation steps are required to do this.

An optical Ising machine according to an example embodiment comprises a splitting tree for splitting a reference optical signal into M beams and at least one reference beam; M intensity and/or phase modulators to encode an input vector of size M by respective amplitudes and/or phases of the M beams; an optical matrix processing unit configured to perform multiplication of the input vector of size M and a matrix of size M×M to generate an output vector of size M encoded on the M beams; a homodyne detection circuit configured to extract respective amplitudes and phases of the M beams after the optical matrix processing unit for determining components of the output vector of size M; and a feedback circuit for applying new phase biases to respective ones of the M intensity and/or phase modulators based on the components of the output vector of size M for a next iteration of the optical Ising machine.

The optical Ising machine may be configured to process a multiplication of a vector of size N>M and a matrix of size N×N, wherein the M intensity modulators are configured to encode a partition of the vector of the size N into the input vector of the size M on the M beams; the optical matrix processing unit is configured to perform multiplication of the input vector of size M and a partition of the matrix of size N×N into the matrix of size M×M to generate the output vector of size M encoded on the M beams; and the homodyne detection circuit is configured to extract respective amplitudes and phases of the M beams after the optical matrix processing unit using the reference beam, for determining the components of the output vector of size M; the optical Ising machine is configured to process all partitions of the vector of the size N and the matrix of the size N×N; and the feedback circuit is configured to apply the new phase biases to respective ones of the M intensity modulators based on the components of all the output vectors of size M of all partitions of the N×N matrix for a next iteration of the optical Ising machine.

The M intensity and/or phase modulators may comprise Mach Zehnder intensity and/or phase modulators.

The homodyne detection circuit may comprise M Mach Zehnder interferometers, each Mach Zehnder interferometer configured to receive one of the M beams after the optical matrix processing unit at a first input and the optical reference optical signal at a second input.

The optical Ising machine may comprise M detectors, each detector configured to receive a first output of one of the Mach Zehnder interferometers and a second output of the one of the Mach Zehnder interferometers at first and second inputs, respectively, for extracting respective amplitudes and phases of the M beams for determining the absolute values and the signs of the components of the output vector of size M.

The feedback circuit may be configured to subtract first and second intensities at first and second outputs of the respective M detectors and to scale by a constant factor for determining the absolute values and the signs of the components of the output vector of size M.

The feedback circuit may be electrical.

The feedback circuit may be analog.

The optical Ising machine may comprise a source of the reference optical signal.

The optical matrix processing unit may comprise two sets of Mach Zehnder interferometers interconnected by attenuators.

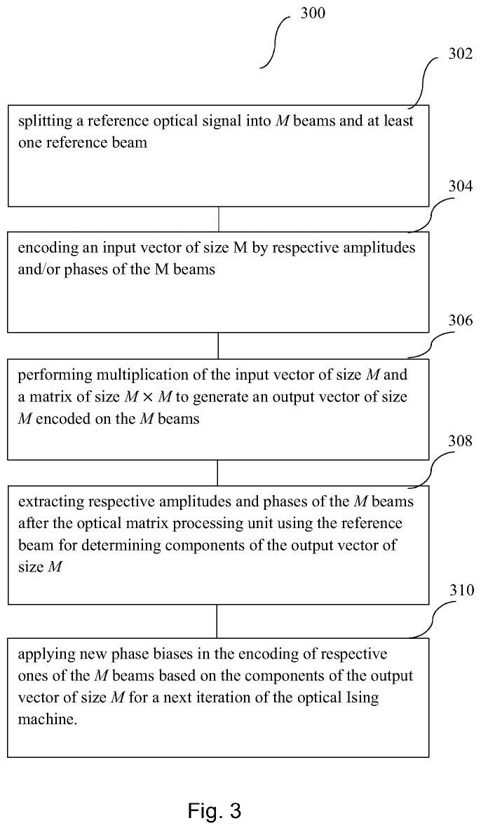

FIG. 3 shows a flowchart 300 illustrating a method of applying an optical Ising machine for solving a combinatorial optimization problem. At step 302, a reference optical signal is split into M beams and at least one reference beam. At step 304, an input vector of size M is encoded by respective amplitudes and/or phases of the M beams. At step 306, multiplication of the input vector of size M and a matrix of size M×M is performed to generate an output vector of size M encoded on the M beams. At step 308, respective amplitudes and phases of the M beams are extracted after the optical matrix processing unit using the reference beam for determining components of the output vector of size M. At step 310, new phase biases are applied in the encoding of respective ones of the M beams based on the components of the output vector of size M for a next iteration of the optical Ising machine.

The method may be applied to process a multiplication of a vector of size N>M and a matrix of size N×N, by encoding a partition of the vector of the size N into the input vector of the size M on the M beams; performing multiplication of the input vector of size M and a partition of the matrix of size N×N into the matrix of size M×M to generate the output vector of size M encoded on the M beams; and extracting respective amplitudes and phases of the M beams after the optical matrix processing unit for the components of the output vector of size M; processing all partitions of the vector of the size N and the matrix of the size N×N; and applying the new phase biases in the encoding of respective ones of the M beams based on the components of all the output vectors of size M of all partitions of the N×N matrix for a next iteration of the optical Ising machine.

The M intensity and/or phase modulators may comprise Mach Zehnder intensity and/or phase modulators.

The homodyne detection circuit may comprise M Mach Zehnder interferometers, each Mach Zehnder interferometer configured to receive one of the M beams after the optical matrix processing unit at a first input and the optical reference optical signal at a second input.

The method may comprise using M detectors, each detector configured to receive a first output of one of the Mach Zehnder interferometers and a second output of the one of the Mach Zehnder interferometers at first and second inputs, respectively, for extracting respective amplitudes and phases of the M beams for determining the absolute values and the signs of the components of the output vector of size M.

The method may comprise subtracting first and second intensities at first and second outputs of the respective M detectors and scaling by a constant factor for determining the absolute values and the signs of the components of the output vector of size M.

The subtracting and scaling may use an electrical feedback circuit.

The method may comprise providing a source of the reference optical signal.

The multiplication of the input vector of size M and the matrix of size M×M may be performed using an optical matrix processing unit comprising two sets of Mach Zehnder interferometers interconnected by attenuators.

Embodiments of the present invention can have one or more of the following features and associated benefits/advantages:

| Feature | Benefit/Advantage |
|---|---|
| Optical | An Optical Ising machine can process information at the |
| implementation | speed of light, making all-optical Ising machines |
| of Ising | exceptionally fast for solving complex optimization |
| interactions | problems. This speed advantage is particularly valuable |
| (high speed) | for real-time decision-making and large-scale |
| | optimization tasks. In an example embodiment, all of |
| | the fast calculation in the Ising algorithm are |
| | implemented with photonics. |
| Scalability | In an example embodiment, a large matrix can be |
| | partitioned into smaller matrices, which can be computed |
| | sequentially. This means that hardware which may be |
| | limited to a certain number of M bits can be arbitrarily |
| | scaled to a much larger number of bits N > M using time |
| | multiplexing but with all of the fast calculation in |
| | the Ising algorithm still performed optically. In an |
| | example embodiment, distribution calculations are |
| | performed through matrix decomposition, and any |
| | number of spins can be achieved. In addition, based |
| | on the ultra-large spin number, a high success rate, |
| | robust noise tolerance, and superior error tolerance |
| | can be obtained. |

Embodiments of the present invention can have one or more of the following industrial applications:
Finance and Portfolio Optimization: Optical Ising machines can be employed to optimize investment portfolios, risk assessment, and trading strategies, helping financial institutions make better decisions and manage their investments more effectively.
Supply Chain and Logistics: Optimizing supply chain and logistics operations, including route planning, resource allocation, and inventory management, can lead to cost savings and improved efficiency.
Drug Discovery: Pharmaceutical companies can utilize Ising machines to optimize drug discovery processes, such as molecular structure analysis and protein folding, accelerating the development of new drugs.
Artificial Intelligence: Ising machines can be used to accelerate certain machine learning and artificial intelligence tasks, particularly in training and optimization processes.
Smart Cities: In the context of smart city initiatives, Ising machines can help optimize traffic management, waste collection, and resource allocation for urban services.
Climate Modeling: Climate researchers can use Ising machines for complex simulations and modeling tasks related to climate change, weather prediction, and environmental conservation.
Cybersecurity: Ising machines can aid in optimizing security protocols and network defense strategies, enhancing protection against cyber threats.

Example fabrication methods/techniques for implementation of an example embodiment

An optical Ising machine according to an example embodiment can be fabricated on a single chip using standard foundry processes. For instance, silicon-on-insulator or lithium niobate-on-insulator would be possible materials in which the implementation could be done. At the input, a single laser is coupled into single mode waveguide and divided by splitting tree and then enter the MPU. Vectors are encoded by standard Mach Zehnder modulators. A possible wavelength of operation is 1.55 μm. The remaining optical components comprise standard Mach Zehnder interferometer meshes, couplers or multimode interferometer, and either on-chip or off-chip photodiodes, all of which are typically part of foundry Process Design Kits (PDKs) for chip-based photonic devices.

The electronic components, such as for driving the Mach Zehnder modulators and the feedback electronics, may be implemented, either on-chip or off-chip, as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits (ASICs). Some other possibilities for implementing aspects of the system include: microcontrollers with memory (such as electronically erasable programmable read only memory (EEPROM)), embedded microprocessors, firmware, software, etc. Furthermore, aspects of the system may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (MOSFET) technologies like complementary metal-oxide semiconductor (CMOS), bipolar technologies like emitter-coupled logic (ECL), polymer technologies (e.g., silicon-conjugated polymer and metal-conjugated polymer-metal structures), mixed analog and digital, etc.

The various functions or processes disclosed herein may be described as data and/or instructions embodied in various computer-readable media, in terms of their behavioral, register transfer, logic component, transistor, layout geometries, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. When received into any of a variety of circuitry (e.g. a computer), such data and/or instruction may be processed by a processing entity (e.g., one or more processors).

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive. Also, the invention includes any combination of features described for different embodiments, including in the summary section, even if the feature or combination of features is not explicitly specified in the claims or the detailed description of the present embodiments.

In general, in the following claims, the terms used should not be construed to limit the systems and methods to the specific embodiments disclosed in the specification and the claims, but should be construed to include all processing systems that operate under the claims. Accordingly, the systems and methods are not limited by the disclosure, but instead the scope of the systems and methods is to be determined entirely by the claims.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

1. An optical Ising machine comprising:
a splitting tree for splitting a reference optical signal into M beams and at least one reference beam;
M intensity and/or phase modulators to encode an input vector of size M by respective amplitudes and/or phases of the M beams;
an optical matrix processing unit configured to perform multiplication of the input vector of size M and a matrix of size M×M to generate an output vector of size M encoded on the M beams;
a homodyne detection circuit configured to extract respective amplitudes and phases of the M beams after the optical matrix processing unit for determining components of the output vector of size M; and
a feedback circuit for applying new phase biases to respective ones of the M intensity and/or phase modulators based on the components of the output vector of size M for a next iteration of the optical Ising machine.

2. The optical Ising machine of claim 1, configured to process a multiplication of a vector of size N>M and a matrix of size N×N, wherein the M intensity modulators are configured to encode a partition of the vector of the size N into the input vector of the size M on the M beams;
the optical matrix processing unit is configured to perform multiplication of the input vector of size M and a partition of the matrix of size N×N into the matrix of size M×M to generate the output vector of size M encoded on the M beams; and
the homodyne detection circuit is configured to extract respective amplitudes and phases of the M beams after the optical matrix processing unit using the reference beam, for determining the components of the output vector of size M;
the optical Ising machine is configured to process all partitions of the vector of the size N and the matrix of the size N×N; and
the feedback circuit is configured to apply the new phase biases to respective ones of the M intensity modulators based on the components of all the output vectors of size M of all partitions of the N×N matrix for a next iteration of the optical Ising machine.

3. The optical Ising machine of claim 1, wherein the M intensity and/or phase modulators comprise Mach Zehnder intensity and/or phase modulators.

4. The optical Ising machine of claim 1, wherein the homodyne detection circuit comprises M Mach Zehnder interferometers, each Mach Zehnder interferometer configured to receive one of the M beams after the optical matrix processing unit at a first input and the optical reference optical signal at a second input.

5. The optical Ising machine of claim 4, comprising M detectors, each detector configured to receive a first output of one of the Mach Zehnder interferometers and a second output of the one of the Mach Zehnder interferometers at first and second inputs, respectively, for extracting respective amplitudes and phases of the M beams for determining the absolute values and the signs of the components of the output vector of size M.

6. The optical Ising machine of claim 5, wherein the feedback circuit is configured to subtract first and second intensities at first and second outputs of the respective M detectors and to scale by a constant factor for determining the absolute values and the signs of the components of the output vector of size M.

7. The optical Ising machine of claim 1, wherein the feedback circuit is electrical.

8. The optical Ising machine of claim 7, wherein the feedback circuit is analog.

9. The optical Ising machine of claim 1, comprising a source of the reference optical signal.

10. The optical Ising machine of claim 1, wherein the optical matrix processing unit comprises two sets of Mach Zehnder interferometers interconnected by attenuators.

11. A method of applying an optical Ising machine for solving a combinatorial optimization problem, the method comprising the steps of:
splitting a reference optical signal into M beams and at least one reference beam;
encoding an input vector of size M by respective amplitudes and/or phases of the M beams;
performing multiplication of the input vector of size M and a matrix of size M×M to generate an output vector of size M encoded on the M beams;
extracting respective amplitudes and phases of the M beams after the optical matrix processing unit using the reference beam for determining components of the output vector of size M; and
applying new phase biases in the encoding of respective ones of the M beams based on the components of the output vector of size M for a next iteration of the optical Ising machine.

12. The method of claim 11, to process a multiplication of a vector of size N>M and a matrix of size N×N, by
encoding a partition of the vector of the size N into the input vector of the size M on the M beams;
performing multiplication of the input vector of size M and a partition of the matrix of size N×N into the matrix of size M×M to generate the output vector of size M encoded on the M beams; and
extracting respective amplitudes and phases of the M beams after the optical matrix processing unit for the components of the output vector of size M;
processing all partitions of the vector of the size N and the matrix of the size N×N; and
applying the new phase biases in the encoding of respective ones of the M beams based on the components of all the output vectors of size M of all partitions of the N×N matrix for a next iteration of the optical Ising machine.

13. The method of claim 11, wherein the M intensity and/or phase modulators comprise Mach Zehnder intensity and/or phase modulators.

14. The method of claim 11, wherein the homodyne detection circuit comprises M Mach Zehnder interferometers, each Mach Zehnder interferometer configured to receive one of the M beams after the optical matrix processing unit at a first input and the optical reference optical signal at a second input.

15. The method of claim 14, comprising using M detectors, each detector configured to receive a first output of one of the Mach Zehnder interferometers and a second output of the one of the Mach Zehnder interferometers at first and second inputs, respectively, for extracting respective amplitudes and phases of the M beams for determining the absolute values and the signs of the components of the output vector of size M.

16. The method of claim 15, comprising subtracting first and second intensities at first and second outputs of the respective M detectors and scaling by a constant factor for determining the absolute values and the signs of the components of the output vector of size M.

17. The method of claim 11, wherein the substrate and scaling use an electrical feedback circuit.

18. The method of claim 17, wherein the feedback circuit is analog.

19. The method of claim 11, comprising providing a source of the reference optical signal.

20. The method of claim 11, wherein the multiplication of the input vector of size M and the matrix of size M×M is performed using an optical matrix processing unit comprising two sets of Mach Zehnder interferometers interconnected by attenuators.
